(19) United States
(12) Patent Application Publication
(10) Pub. No.: US 2006/0053202 A1
(43) Pub. Date: Mar. 9, 2006

(54) Method and system implementing secure email

(76) Inventors: Chris Foo, Costa Mesa, CA (US); Yoon-Chok Chin, Richmond Hill (CA)

Correspondence Address: Chris Foo, P.O. Box 28151, Santa Ana, CA, 92799, US

(21) Appl. No.: 10/936,688

(22) Filed: Sep. 9, 2004

(51) Int. Cl. G06F 15/16

(52) U.S. Cl. 709/206

(57) ABSTRACT

This method and system was developed to reduce the email spam and viruses embedded in the attachment and to provide a more secure method to deliver email messages. In addition, the internet link in the email message will be verified to eliminate email fraud. Using this implementation, email messages never physically transmit to recipient's system. An email notification will be sent to recipient and the message will be retrieve from sender's system.

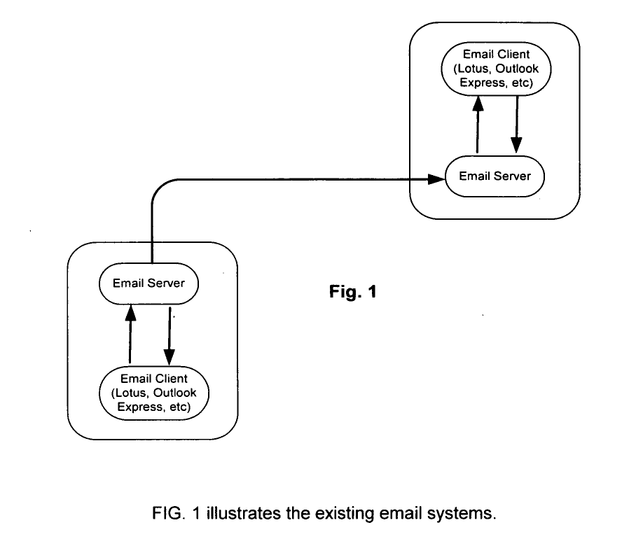

FIG. 1 illustrates the existing email systems. Using email client program, user compose email message and transmit from his or her email server to recipient's email server as file. Recipient will retrieve the email file from the server via his or her email client program. The existing systems create many problems where:
1. Email messages are physically transmit to recipient's server thus the sender will not be able to verify if the message has been read.
2. Viruses are often spread via email attachment. If the recipient opens the infected attachment, the virus can spread to other network radically.
3. Recipient often use anti spam program to filter spam emails. Unfortunately this approach is not very effective as senders often masks their identity to avoid being filter out.
4. Due to the fact that email messages are transmit from server to server, some systems installed with scanning program will be able to scan the messages searching for keywords that target the recipient with certain advertisements.
5. The encryption program is required to install on both sender and recipient's computer in order to encrypt and decrypt email messages.
6. Email messages can consist of hyperlink that allow recipient to open the corresponding website by clicking on the hyperlink. Unfortunately, Phishing email schemes are getting more common where users who click on the links are taken to look-alike sites where they are asked to enter personal data.

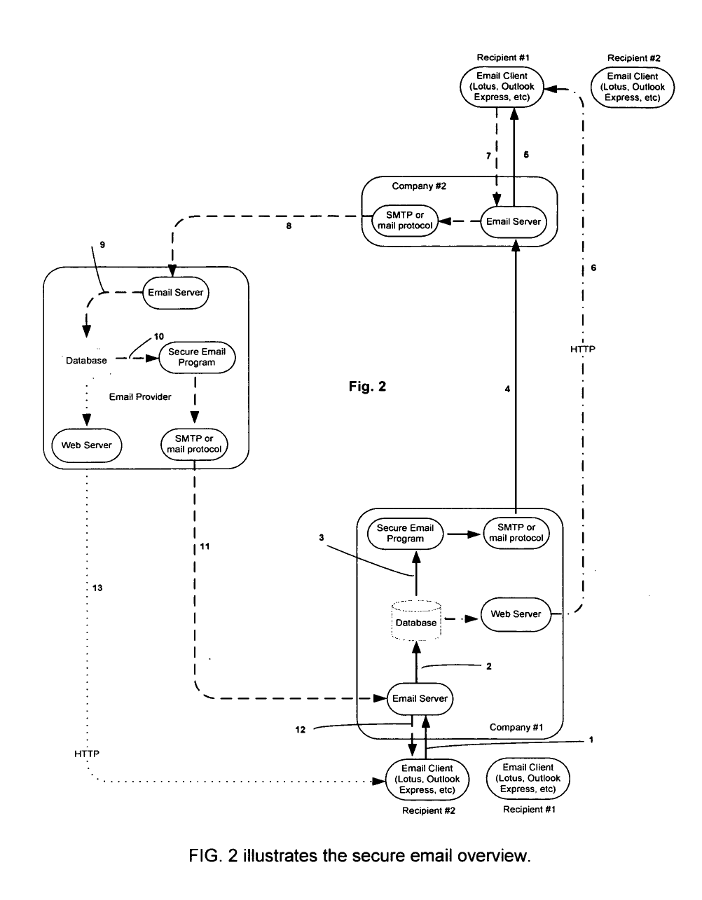

FIG. 2 illustrates the secure email overview. 1 Using email client program, user compose email message. 2 Email server program that interacts with the email client program received the email message and begin scanning for any viruses. If no virus exists, the email message will be stored in the database along with all the recipients email addresses. 3 At predefined intervals, the Secure Email Program will generate a notification corresponds to the email messages to each recipients with a unique message id. 4 The Secure Email Program will then interact with SMTP server or other mail protocol and transmit the notification the recipient's email server. 5 Using email client program, recipient will then retrieve the email notification from his or her email server. To authentic the notification email, the recipient can verify his or her secure signature display on the notification email. 6 By clicking on the notification message, recipient will be able to retrieve the email message resided in the sender's database via http protocol. Upon successfully completed the authentication; sender's web server will decrypt the message and display the message on recipient's browser. There are two approaches where recipient can reply to the message. The first approach is to click on the reply button display on the same web page where the email message is displayed. This approach required recipient's information such as authentication password and secure signature to be created in sender's database.

The second approach is where recipient use the client email program to reply to the message. 7 In this approach, recipient will compose the reply message using his or her client email program such as Microsoft Outlook Express. 8 The email client program will interact with its SMTP or other mail protocol and transmit the message to a email server. This email server can either resides on recipient location or a third party provider. If the email server is maintain by a third party provider, the recipient's authentication password and secure signature are required to be created on this third party provider's database as well. Otherwise, recipient's secure signature will not be included in the notification email. The email server will then begin the authentication process to verify the source of the message and encrypt the message into database if no virus was found. Eventually, 10 the Secure Email Program will generate a notification correspond to the message and 11 transmit to the sender via SMTP or other mail protocol. 12 The reply notification will be delivered to recipient's client email program. Recipient will verify his or her secure signature and 13 retrieve the reply message by clicking on the notification encrypted message id.

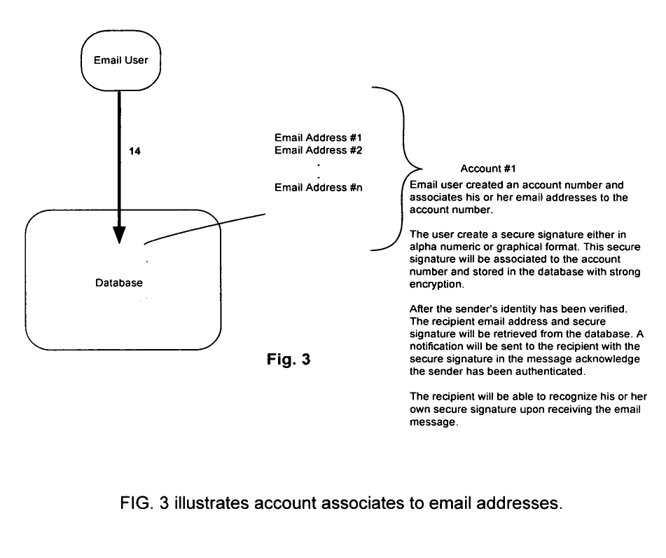

FIG. 3 illustrates how account associates to email addresses. The user first required to create a unique account number. Let say the email provider in FIG. 2 is Xyz Company. The account can be chris@xyz.com where chris is the unique alpha number character to identify the user. Using this account number, the user then create a foreign key value correspond to his or her other email addresses stored in the database such as chris@hotmail.com and chris@yahoo.com. The user then required to create a unique signature either in alpha numeric or graphical format where he or she can easily remember. 14 This secure signature will be encrypted and stored in the database along with his or her other information such as account number and email addresses. 15 To activate or authenticate the account number, the user will be required to acknowledge the verification email generated by Secure Email Program. 16 This verification email only generated the first time the account number receive an email message. This authentication process is valid for a period of time depending on how it was setup in the server.

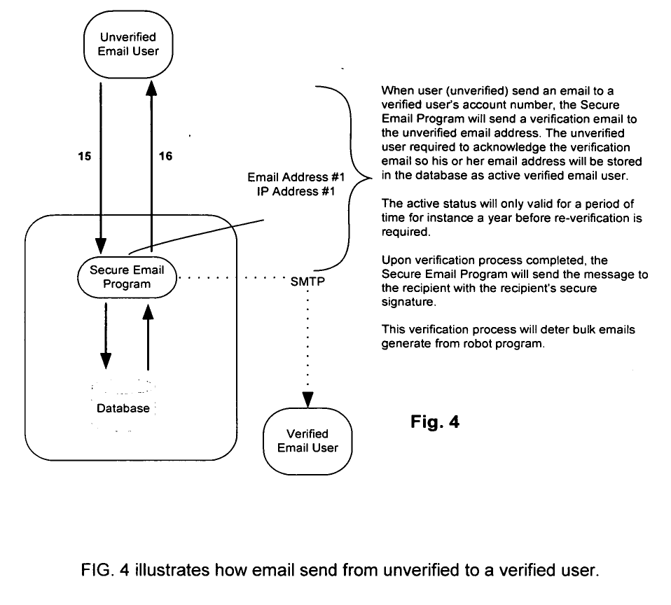

FIG. 4 illustrates how email send from unverified to a verified user.

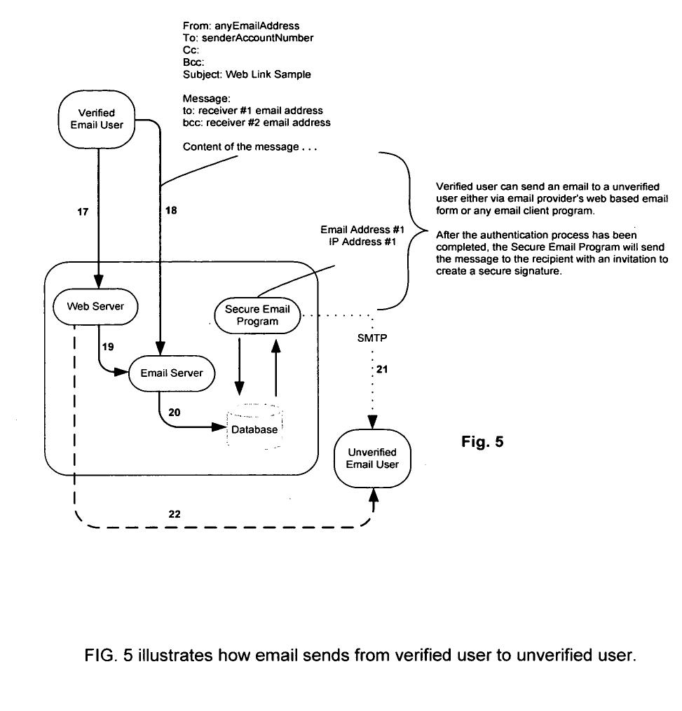

FIG. 5 illustrates how email sends from verified user to unverified user. 17 Verified user can send an email to a unverified user either via email provider's web based email form or any email client program. If sending from a email client program, the “to address” needed to be the sender's account number as the email message will be encrypted and stored in the database under the sender's account number. 18 The recipient of the email message will be entered in the beginning of the message content with text beginning with “to:”, “cc:” or “bcc:”. The Secure Email Program will always parse the message text searching for the syntax before the message store in the database. 21 A notification is then generated and transmits to each recipient via SMTP or other mail protocol. 22 Upon confirm the secure signature, the recipient retrieve the message via web browser.

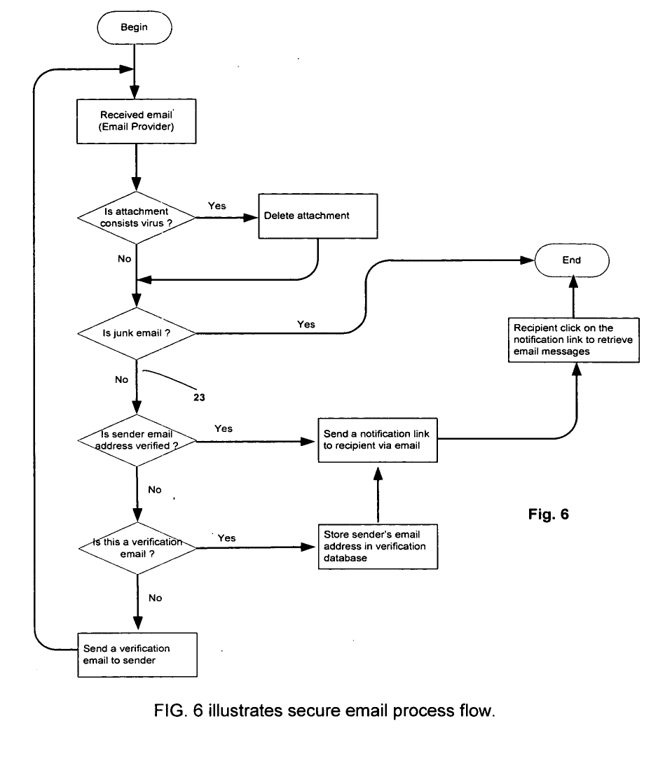

FIG. 6. illustrates secure email process flow. When the Secure Email Program receives email messages, its first task is to scan for viruses in the attachment. It then verify if the email message is a spam mail by check the maximum number of emails sent by the sender within predefined intervals. Any hyperlink embedded in the message will also be verified to ensure its integrity.

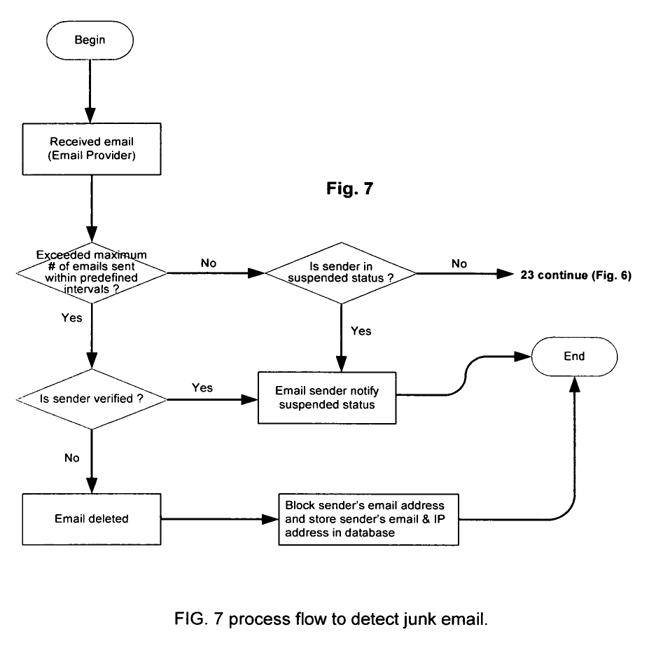

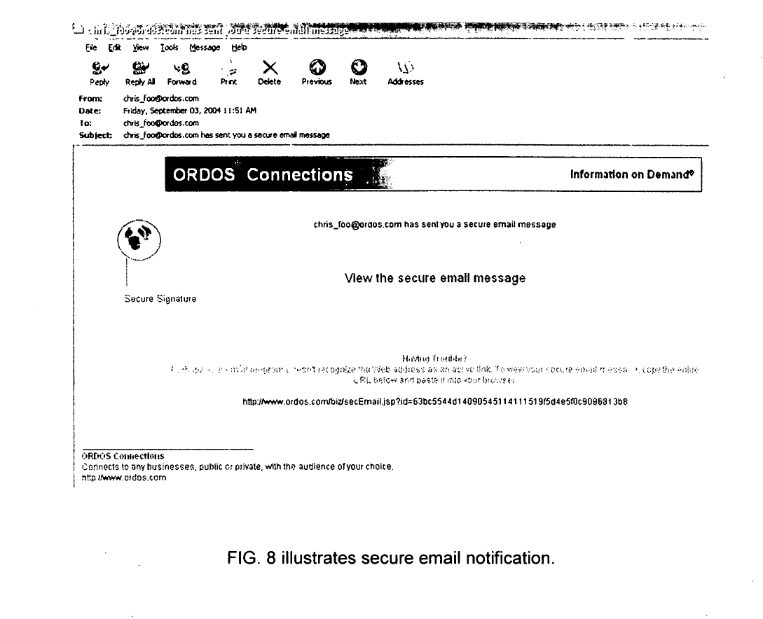

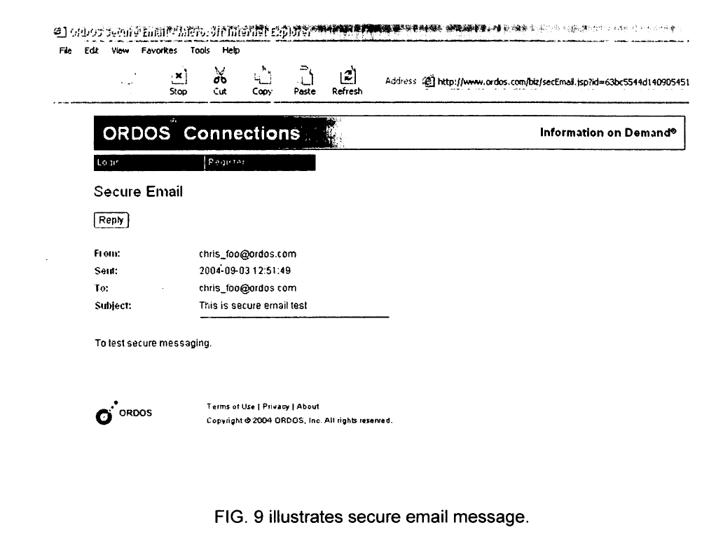

FIG. 7 illustrates the process flow to detect spam email.

### BACKGROUND

Email is one of the most popular medium of communication; however, it is also inherently insecure to exchange any private messages. How messages we thought deleted could be sitting on servers half way around the world years being sent, how people can read and modify messages in transit, and how the very username and password that we use to login to email servers can be stolen and used by hackers. In addition, email is also one of the most popular medium used to spread viruses. Therefore, a new methods and apparatus are needed to resolve these problems as well as improve the efficiency and security of email infrastructure.

### SUMMARY

Methods and apparatus consistent with the present invention, as embodied and broadly described herein, provide a secure process to retrieve message content without physically deliver the message content to recipient's email server. This approach not only eliminate the possibility of message being modify while in transit, but also provide the sender the responsibility of when the message will be deleted from the server.

In addition, this process also included functionalities to detect spam emails by analyzing the number of emails sent in predetermined intervals and scan the content for any embedded viruses.

Any embedded hyperlink in the messages will also be authenticated to prevent any fraudulent redirection.

What is claimed is:

1. A computer-implemented method to deliver secure email message over a network. The method comprising: create account number; compose email message with email client program; verify sender's information; received email message by secure email program; insert and encrypt email message into database; generate email notification to recipient; received email notification; retrieve email message.

2. The method of claim 1, wherein create account number comprises the steps of: create a unique id in database; create unique signature; associate email addresses to unique id created.

3. The method of claim 2, wherein unique id comprises alpha numeric content.

4. The method of claim 2, wherein unique signature comprises one of alpha numeric or graphical content.

5. The method of claim 2, wherein associate email addresses to unique id created comprises steps of: create a foreign key with unique id in every email addresses records store in the database.

6. The method of claim 1, wherein email client program is a computer software program that interacts with mail server program.

7. The method of claim 1, wherein verify sender's information further comprises steps of: authentic sender's Internet Protocol addresses; verify message content.

8. The method of claim 7, wherein authentic sender's Internet Protocol addresses further comprises steps of: verify if sender exceeded maximum number of emails sent within predetermined intervals; verify sender's account is active status.

9. The method of claim 8, wherein exceeded maximum number of emails further comprises steps of: suspend sender's account; send notification to sender if required.

10. The method of claim 8, wherein verify sender's account status comprises steps of: verify if sender's status is active, permanent or temporary suspended.

11. The method of claim 10, wherein suspended status comprises steps of: contacting sender via other means of communications such as phone call.

12. The method of claim 7, wherein verify message content comprises steps of: scan attachment if virus exists; authentic embedded web link; delete email if virus found or authentication failed.

13. The method of claim 12, wherein authentic web link comprises steps to verify embedded forward hyperlink address matches the display hyperlink address.

14. The method of claim 1, wherein received email message by secure email program comprises steps of: verify sender's email address; verify if message content is for verification.

15. The method of claim 14, wherein verify if message content is for verification comprises steps of: update sender's account status.

16. The method of claim 1, wherein insert and encrypt email message into database comprises steps of: encrypt message content; insert encrypted message content into database; generate a unique id corresponds to the message.

17. The method of claim 16, wherein unique id is a unique sequential number generated to identify message for each recipients.

18. The method of claim 1, wherein generate email notification to recipient comprises steps of: encrypt unique message id; generate notification message with embedded message id; transmit notification to each recipient.

19. The method of claim 18, wherein embedded message id comprises steps of: insert forward hyperlink with encrypted message id in the notification message; retrieve recipient's unique signature stored in the database; insert recipient's unique signature in the notification message.

20. The method of claim 1, wherein received email notification comprises steps of recipient receive email notification with embedded message id; verify recipient's signature in the message.

21. The method of claim 1, wherein retrieve email message comprises steps of: click on the embedded hyperlink to retrieve message content; enter username and password to decrypt message content; update message status in database correspond to recipient's message id to status retrieved.
